(19) United States
(12) Patent Application Publication
(10) Pub. No.: US 2019/0027072 A1
(43) Pub. Date: Jan. 24, 2019

(54) Racing Vehicles Incorporating Digital Signs For Increased Advertising Opportunities and Reduced Operating Costs

(71) Applicant: Don Labowsky, Chalfont, PA (US)

(72) Inventor: Don Labowsky, Chalfont, PA (US)

(21) Appl. No.: 16/042,988

(22) Filed: Jul. 23, 2018

Related U.S. Application Data
(60) Provisional application No. 62/535,287, filed on Jul. 21, 2017.

(51) Int. Cl. G09G 3/00; G09F 21/04; G09F 21/08

(52) U.S. Cl. CPC G09G 3/004; G06F 3/14; G09F 21/08; G09F 21/048

(57) ABSTRACT

A racing vehicle for providing dynamic advertisement opportunities includes a digital sign or digital signs mounted thereto. Digital sign(s) can present content in different manners. Digital sign(s) may receive content and instructions for presenting the content via a user interface or from an external device via a communication interface (e.g., wireless interface). Digital sign(s) include a mobile power source (e.g., battery, fuel cell, solar cell). Digital sign(s) may be preformed to fit on a specific portion of the racing vehicle and be secured to the body or frame of the racing vehicle in various manners. Content presented on the digital sign may be changed per event that the racing vehicle partakes in and thus provides additional advertisement opportunities for the racing vehicle. The racing vehicle is any type of competitive vehicle, including single wheel vehicles, two-wheel vehicles, four-wheel vehicles, tracked vehicles, flying vehicles and water vehicles.

### PRIORITY

This application claims the priority under 35 USC § 119 of Provisional Application 62/535,287 filed on Jul. 21, 2017, entitled “Digital Signage for Racing Vehicles” and having Don P. Labowsky as inventor. Application 62/535,287 is herein incorporated by reference in its entirety.

### BACKGROUND

Motorsports competition involving vehicles racing are exciting for participants, engaging for spectators and viewers, and highly-valued broadcast content for sponsors and advertisers. The vehicles may race on or in various types of tracks (e.g., concrete, pavement, dirt, snow, water, air). The tracks may include straight and/or curved sections. The tracks may be permanent structures or may be temporarily set up in different venues. Signage (e.g., names, logos, messages) may be provided on the race vehicles. The signage may provide a source for recognition, communication, and/or the creation of advertising impressions. For example, the signage may identify sponsors, owners, drivers, and/or suppliers of the race vehicles or component parts. The signage may be provided on the racing vehicles using permanent (paint) or semi-permanent (adhesive-backed decals) markings.

Changing the permanent or semi-permanent signage on the race vehicles is slow, time-consuming, and costly. Accordingly, the signage provided on the race vehicle typically is maintained for a period of time. Racing vehicles cannot be used by multiple drivers or sponsors in a given day due to the permanent or semi-permanent nature of the signage, requiring the use of additional racing vehicles and increasing the overall cost of racing. Identifying the main driver of a race vehicle on the race vehicle signage may result in other drivers not wanting to drive the race vehicle as they are not identified or those drivers not getting the benefit of the recognition provided by the signage. Those taking advantage of the advertisement opportunities in the signage likely pay a premium as they will be exposed for multiple events. This may limit those that can advantage of the advertisement opportunities to those that can afford it or those that have a large demographic and geographic target market where exposure at multiple events is desired.

For example, if a race vehicle partakes in two races during an event the same advertisements are provided at each race rather than each race having a different advertiser. This is not beneficial if the races have different expected audiences that would have different interests and thus be attracted by different advertisements. For example, an advertisement for alcohol may not be desirable for an earlier race where the expected audience may be younger while the alcohol advertisement may be desirable for a later race where the expected audience is older. Likewise, a video game advertisement may be applicable to the first race but not the second race. Therefore, to participate in two races, two separately-lettered vehicles would currently be required.

If the race vehicle partakes in races in various regions of the country the same advertisements may be provided if there isn't time or money to change the signage. Regional businesses may not want to advertise outside of their region. For example, a food chain in a specific part of the country would only want to advertise where their stores were located and not in locations outside of the are they service.

The static nature of the signage also limits the ability of owner of the race vehicle to provide additional advertising opportunities to other parties or to provide targeted advertisement opportunities. What is needed is the ability to quickly change the signage on the racing vehicles. The ability to quickly change the signage provides additional advertising opportunities including enabling a single race vehicle to provide different advertisements opportunities based on any number of parameters (e.g., time, location, venue, expected audience, driver).

### BRIEF DESCRIPTION OF THE DRAWINGS

The features and advantages of the various embodiments will become apparent from the following detailed description in which:

FIG. 1 illustrates an example high level functional diagram of a digital sign;

FIGS. 2A-C illustrate an example use of digital sign(s) on a go-kart, according to one embodiment;

FIGS. 3A-C illustrate an example use of digital sign(s) on a racing car, according to one embodiment;

FIGS. 4A-B illustrate an example use of digital sign(s) on a racing motorcycle, according to one embodiment;

FIG. 5 illustrates an example use of digital sign(s) on a drone, according to one embodiment; and

FIG. 6 illustrates an example high level flow diagram for using digital sign(s) on a racing vehicle, according to one embodiment.

### DETAILED DESCRIPTION

Digital signage is a form of signage that includes some type of display device that presents content that is programmed therein in some fashion. The display device may simply be capable of presenting alpha-numeric content or may be capable of providing content that could be presented on a television or computer monitor. The digital signage enables a user to create and/or define the content that is presented. The content may be static (e.g., fixed image) or may be dynamic (e.g., scrolling, flashing, changing). The content that is displayed and the manner in which it displayed may be defined by a user. The user may have the content that is to be presented at different times pre-configured so that the content displayed can easily be changed at any time. The content may also be created dynamically by the user as it is needed.

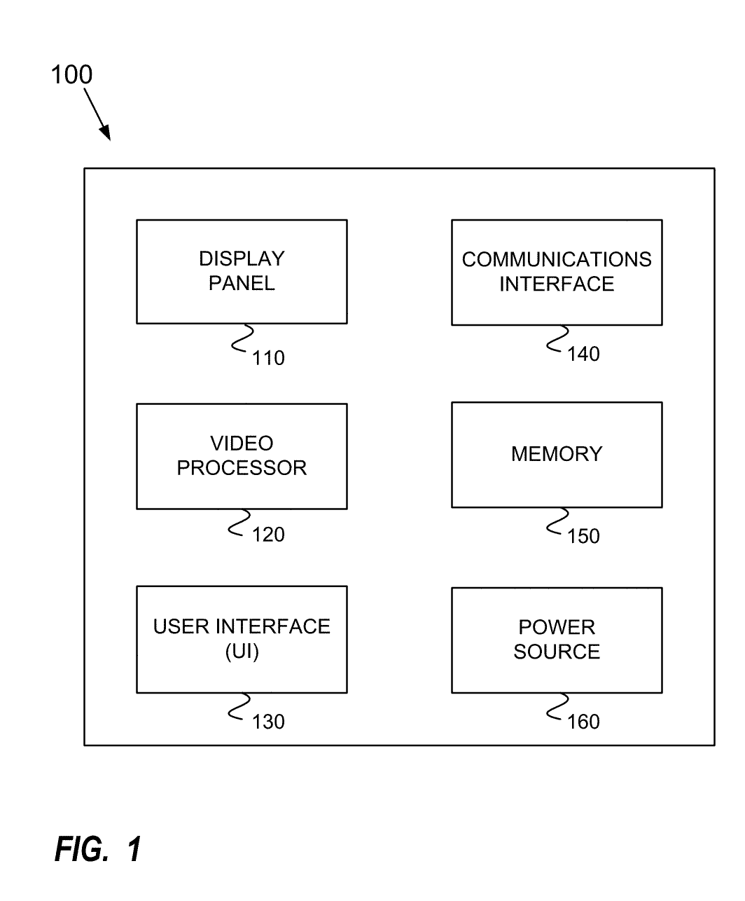

FIG. 1 illustrates an example high level functional diagram of a digital sign 100. The digital sign 100 includes a display panel 110, a processor 120 (e.g., video processor), a user interface 130, memory 140 and a power source 150. The display panel 110 presents the content. As noted above, the display may simply be an LED sign capable of displaying alpha-numeric content or may be a display capable of presenting text, graphical images, photo's and/or video's. The processor 120 instructs the display panel 110 on what to present thereon (e.g., what LEDs to light, what pixels to illuminate) and may also prepare the content for presentation on the display panel 110.

The user interface 130 is to communicate with a user, for example, to receive the content that is to be displayed and any instructions related to how the content should be presented. The user interface 130 may be, for example, buttons, switches and/or a keypad that is part of the digital sign 100. Alternatively, the user interface 130 may be a separate component (e.g., remote control) that communicates with the digital sign 100. For example, the digital sign 100 may include an infrared (IR) receiver that receives commands from an IR remote control. The user interface 130 may be used to simply turn the digital sign on/off or to set certain parameters associated therewith (e.g., brightness). The user interface 130 may be capable of entering the content to be presented on the display panel 110.

The digital sign 100 may include a communications interface 140 for communicating with external devices. The communications interface 140 may be a wired interface (e.g., USB, coaxial, Ethernet) or a wireless interface (e.g., WiFi, Bluetooth). The external devices may include, for example, computers, tablets, smart phones, or the track's timing system. The external devices may be capable of generating the content to be displayed and the instructions for how the content is to be displayed and providing this information to the digital sign 100 via the communications interface 140. The track's timing system may indicate the winner of a race by sending a signal to the winning vehicle's sign to display that it won. The external devices may have programs running thereon that enable the content/instructions to be generated or may connect to, for example, a cloud based system that enables the content to be generated.

The memory 150 is to store content to be presented on the display panel 110 and/or instructions for the manner in which the content is to be presented. The content and/or instructions may be received via the user interface 130 and/or the communications interface 140. Alternatively, the memory 150 may be external memory (e.g., USB drive) that has the content and/or instructions stored thereon and is received by the digital sign 100. The memory 150 may be memory on an external computing device (e.g., computer, tablet, smart phone) that can be accessed by the digital sign 100 via the communications interface 140.

The power source 160 is to provide power to the digital sign 100. The power source 160 may be internal or may be external. The power source 160 may be an AC power source (e.g., plug device into electrical outlet), a battery or any mobile electrical source (e.g., fuel cell, solar cell).

What is presented on the digital sign 100 is based on the content and the instructions that are received. The content and the manner it is displayed may stay the same until instructed to change. For example, words and/or images may be presented on the display device 110 in a static manner or with the words and/or images scrolling across the display panel 110. Alternatively, the content presented on the display panel 110 may change based on different parameters (e.g., timing, time of day, brightness). For example, the digital sign 100 may display a first image for first period of time (e.g., few seconds, few minutes), then scroll a first message over the first image for a second period of time (could be same or different than first period of time), then switch to flashing a second message on a second image for a third period of time (could be same or different than first and/or second period of time) and then begin the process again. By way of another example, the digital sign 100 may increase the brightness of the content being presented if, for example, it is determined that the environment is dark (e.g., based on the time of day if the digital sign 100 includes a clock, based on brightness surrounding the digital sign 100 if a photosensor or the like is included in the digital sign 100).

The content being presented on the digital sign 100 may be changed when new content and/or instructions are received via the user interface 130 or communications interface 140. Alternatively, different content and instructions may already be stored in the memory 150 and a user may switch the content being presented by providing instructions via the user interface 130 or communications interface 140. The content/instructions may be changed at any time that a user desires to change the content. For example, the digital sign 100 may display an advertisement for breakfast in the morning and dinner in the evening.

Digital signs 100 may come in different shapes (e.g., square, rectangle) and sizes. The display panel 110 and other components may reside within a frame. Recent advances in display technology enable display panels 110 to be made of flexible material. The use of flexible materials allows the display panels to be used in manners that were not possible with typical displays that were housed in a frame and had a fixed footprint. The flexible displays may be rolled up for storage when not in use and then rolled out and placed in an appropriate location for use. For example, a flexible display could be used in a clam shell device that enables the device and display to be folded when not in use. The flexible displays may applied around different objects (e.g., draped over a chair). Flexible displays may be formed to have a certain footprint and then be secured in that footprint by forming some type of frame therearound the flexible display. This enables displays to come in various shapes, sizes and configurations.

Using a flexible display within a digital sign 100 enables the digital sign to be molded into shape for different environments or to have the digital sign preformed to be used in different environments.

The use of one or more digital signs on a race vehicle provides additional advertising opportunities and may provide for targeted advertising to specific groups (e.g., demographics, geography). The use of the digital sign(s) on the racing vehicles enables different content to be presented at different points in time. The digital sign(s) may be programmed to display different content (e.g., images, names, messages, message patterns) when the racing vehicle is stationary (e.g., prior to or after the race) versus when it is moving (e.g., during the race). The digital sign(s) allow for easy and quick name and message changes between races, where the races may be conducted on different days or may be conducted on the same day (as some events may include multiple races).

The digital sign(s) enable different drivers and/or teams to be identified on the vehicle when they are using the racing vehicle. The digital sign(s) enable the racing vehicle to be adapted for a different set of sponsors, owners, drivers, suppliers, and/or teams per event and/or race within an event or competition. This will allow a racing vehicle to be used by multiple sponsors, owners, drivers, suppliers, and/or teams, reducing the overall cost of racing.

The digital sign(s) may be programmed prior to each race based on, for example, vehicle, team, driver, race event, race day, race time, and sponsors. The programming of the digital sign(s) may configure the content displayed and the manner in which it is displayed. Specific content and display instructions may be assigned to, for example, individual vehicles, vehicle's sponsors, team, team sponsors, driver, driver sponsors, event, race and/or location. The appropriate content may be displayed based on the identification of the vehicle, vehicle's sponsors, team, team sponsors, driver and/or driver sponsors. The digital sign(s) can be updated in real time, for example, identify that a particular vehicle, driver, and/or team won a competitive event or for advertisers to offer discounts based on the result of the race (e.g., $1.00 off any menu item at a restaurant advertising on the racing vehicle when the racing vehicle wins the race).

The selection of the digital sign to be utilized on a racing vehicle may depend on the type of race vehicle being used and the location of the digital sign on the race vehicle. For example, if a flat surface is available for securing the digital sign to the race vehicle a standard digital sign may be used. The digital sign may be mounted to the racing vehicle using, for example, screws, adhesive, and brackets. The digital sign may be mounted to the frame of the racing vehicle or may be mounted to the walls of the racing vehicle. According to one embodiment, the racing vehicle may have a frame mounted thereto for receiving the digital sign. The digital sign should be secured to the racing vehicle in such a fashion that it won't fall off during a race. The digital sign should be mounted so that it may be removed for repair and/or replacement of the digital sign or repair to the racing vehicle.

When the racing vehicle does not include a flat surface that would make the mounting of a standard digital sign possible, flexible digital signs may be utilized. The flexible digital signs may come in an appropriate size so that they will fit on the defined location and then be shaped to fit the location (e.g., placed on, over, or around curved sections) and secured thereto. For example, a flexible digital design may be rolled out and secured to the contours of a trunk or fender of a car and then secured thereto.

Alternatively, a flexible digital design may be preformed to a specific shape to fit on the race vehicle and molded in that shape. The preformed digital design may then be placed on the location of the vehicle and secured thereto. The preformed digital sign may be formed so as to follow a contour of, for example, hood, fender, side panels, doors, and/or trunk of the racing vehicle. The preformed digital sign can then be mounted to the appropriate sections of the racing vehicle. According to one embodiment, a section of the vehicle (e.g., trunk) may be removed and the preformed digital sign may be mounted directly to the frame of the vehicle in place of the actual section.

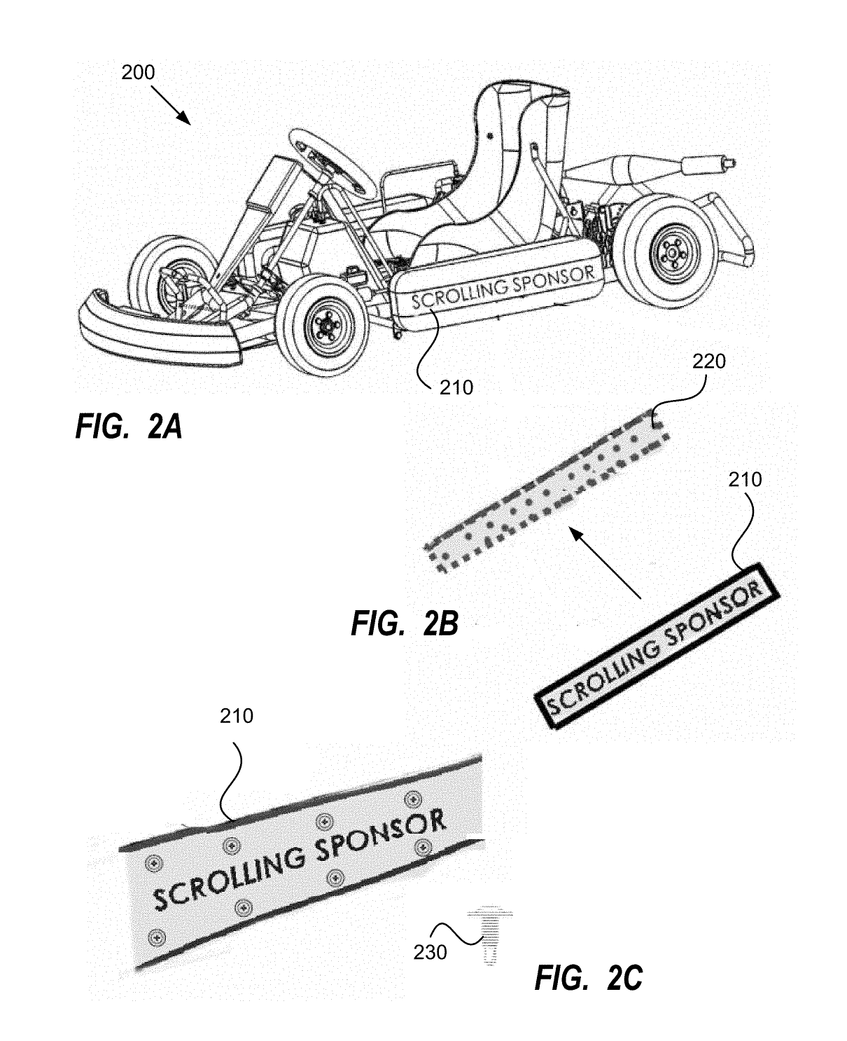

FIGS. 2A-C illustrate an example use of digital sign(s) on a go-kart 200. As illustrated, the go-kart 200 includes at least one digital sign 210 on at least one side thereof. The digital sign(s) 210 may be flexible displays that have been pre-formed to the shape of the portion of the go-kart 200 they will be placed on. The location and number of the digital signs is in no way limited to the illustrated locations.

FIG. 2B illustrates the digital sign 210 being secured to the go-kart 200 (using an adhesive layer 220. The adhesive layer 220 may be applied to the go-kart 200 and then the digital sign 210 may be secured to the go-cart 200 by placing it on the adhesive layer 220. When the adhesive layer 220 dries a secure bond is formed with the digital sign 210 and the sign 210 is secured to the go-kart 200. The digital sign 210 may be removed from the go-kart 200 by, for example, using heat or a solution to dissolve the adhesive layer 220.

FIG. 2C illustrates digital sign 210 being secured to the go-kart 200 using screws 230 or the like. The digital sign 210 may have holes formed therethrough for receiving the screws 230. As illustrated, the digital sign 210 is secured using screws along each of the top and bottom edge but is in no way limited thereto. The go-kart 200 may also have holes (e.g., threaded holes) formed therein for receiving the screws 230.

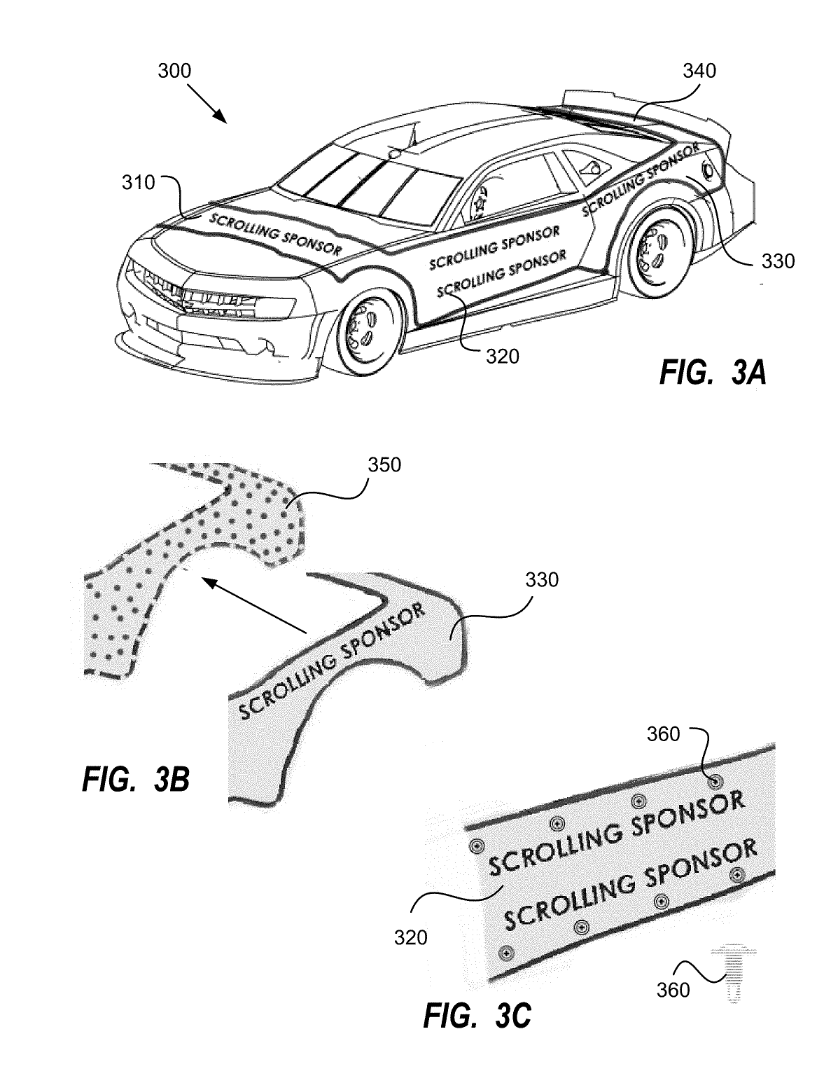

FIGS. 3A-C illustrate an example use of digital sign(s) on a racing car 300. As illustrated, the car 300 includes digital signage on the hood, doors, rear fenders, and trunk. Each section of the vehicle may include its own digital sign (hood 310, door 320, rear fender 330, trunk 340). The digital signs 310, 320, 330, 340 may be flexible displays that have been pre-formed to the shape of the portion of the car 300 they will be placed on. The digital signs 310, 320, 330, 340 are illustrated as touching one another so as to form a continuous display around the car 300 but are in no way limited thereto. The location and number of the digital signs is in no way limited to the illustrated locations. Rather, any number of digital signs can be placed at any location without departing from the current scope of the invention. For example, a digital sign may be placed on the roof or the front grill in addition to those illustrated or in place of one or more of them. A single digital sign may cover multiple portions of the car 300 (e.g., a single digital sign may cover rear fenders and trunk). Multiple digital signs may be located on one location (e.g., the hood may include a plurality of digital signs).

The digital signs 310, 320, 330, 340 are all illustrated as presenting a scrolling sponsor but are in no way limited thereto. The content displayed need not be scrolling and need not be an actual sponsorship. Any type of content may be presented on any of the digital signs without departing from the current scope. The content displayed on the various digital signs 310, 320, 330, 340 may be coordinated (e.g., content on each display is associated with each other, content scrolls from one display to the next) or may be independent of each other.

FIG. 3B illustrates a digital sign (e.g., the digital sign 330) being secured to the car 300 (e.g., the rear fender) using an adhesive layer 350. The adhesive layer 350 may be applied to the car 300 and then the digital sign 330 may be secured to the car 300 by placing it on the adhesive layer 350. The use of an adhesive layer 350 on the rear fender is simply an example and is not intended to limit the invention in any way. Rather, the adhesive layer 350 may be used on any portion of the car 300 and the digital sign 330 need not be secured to the rear fender using the adhesive layer 350.

FIG. 3C illustrates a digital sign (e.g., the digital sign 320) being secured to the car 300 (e.g., the door) using screws 360 or the like. The digital sign 320 may have holes formed therethrough for receiving the screws 360. The doors may also have holes (e.g., threaded holes) formed therein for receiving the screws 360. According to one embodiment, a shell of the door may be removed and the digital sign 320 may be secured directly to the frame of the door. The use of screws 360 to secure the digital sign 320 to the doors is simply an example. The screws 360 may be used on any portion of the vehicle 300 and the digital sign 320 need not be secure to the door using the screws 360.

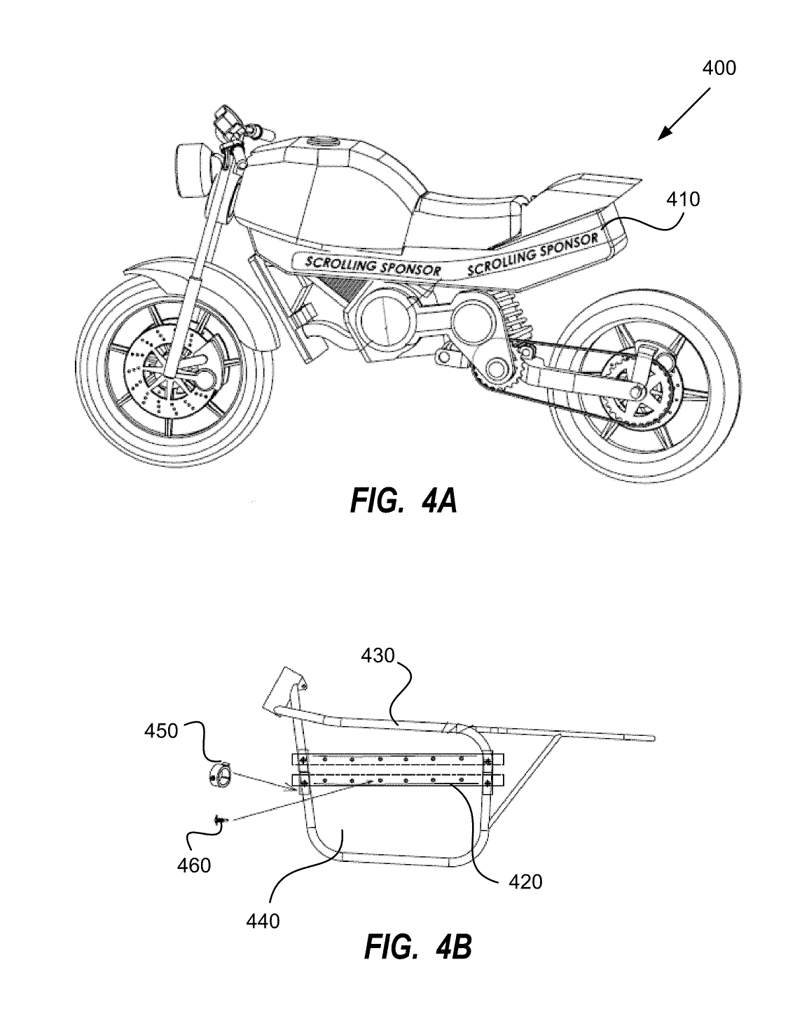

FIGS. 4A-B illustrate an example use of digital sign(s) on a racing motorcycle 400. As illustrated, the motorcycle 400 includes digital sign(s) 410 on a center portion thereof. The number and location of the digital signs is in no way intended to be limited thereby. If the digital sign is placed over a location that has no means for the digital sign to be secured thereto (e.g., no frame, no walls) a support may be required.

FIG. 4B illustrates support bracket(s) 420 being mounted to a frame 430 that forms an open section 440. The support bracket(s) 420 may be mounted so as to cross over the open section 440. The support bracket(s) 420 may be secured to the frame 430, for example, with screws or couplings 450. The digital sign 410 may be secured to the support bracket(s) 420 using, for example, screws 460. The support bracket(s) 420 may also have holes (e.g., threaded holes) formed therein for receiving the screws 460.

The use of the support bracket(s) 460 to secure the digital sign 410 to the frame 420 is simply an example. The digital sign 410 may be secured directly to the frame 420 or a portion of the body of the motorcycle 400 without departing from the current scope.

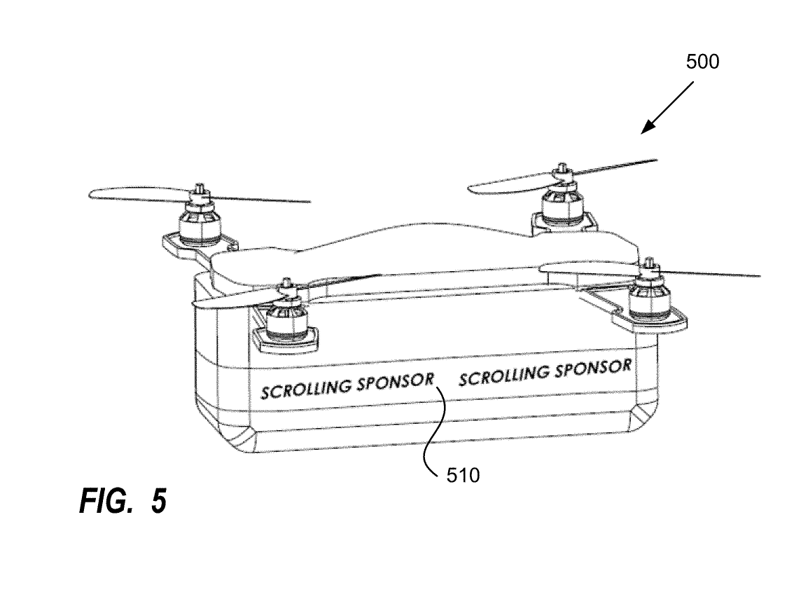

FIG. 5 illustrates an example use of digital sign(s) on a drone 500. As illustrated, the drone 500 includes digital sign(s) 510 located on at least one side thereof. The number and location of the digital signs is in no way intended to be limited thereby. The digital sign(s) 510 may be secured to the drone 500 in various manners such as those previously described that include screws, adhesive and brackets.

The race vehicles that the digital signs may be mounted to include all types of competitive vehicles, including single wheel (e.g., unicycle), two-wheel (e.g., motorcycles, hoverboards, skateboards, Segways), four-wheel (e.g., go-karts, cars, trucks, tractors, skateboards, lawn mowers), tracked (e.g., snowmobile), and others (e.g., drones, hovercrafts, sailboats, motorboats).

The digital sign (e.g., standard, pre-formed, flexible) for racing vehicles may be powered by a mobile power source (e.g., battery, fuel cell, solar cell). The mobile power source may be part of the digital sign, may be a separate device that is stored somewhere on the racing vehicle to power a single digital sign or multiple digital signs, or may be part of the racing vehicle (e.g., the vehicle's battery). If the mobile power source is not part of the digital sign, wires will be necessary to hook the digital sign to the external mobile power source.

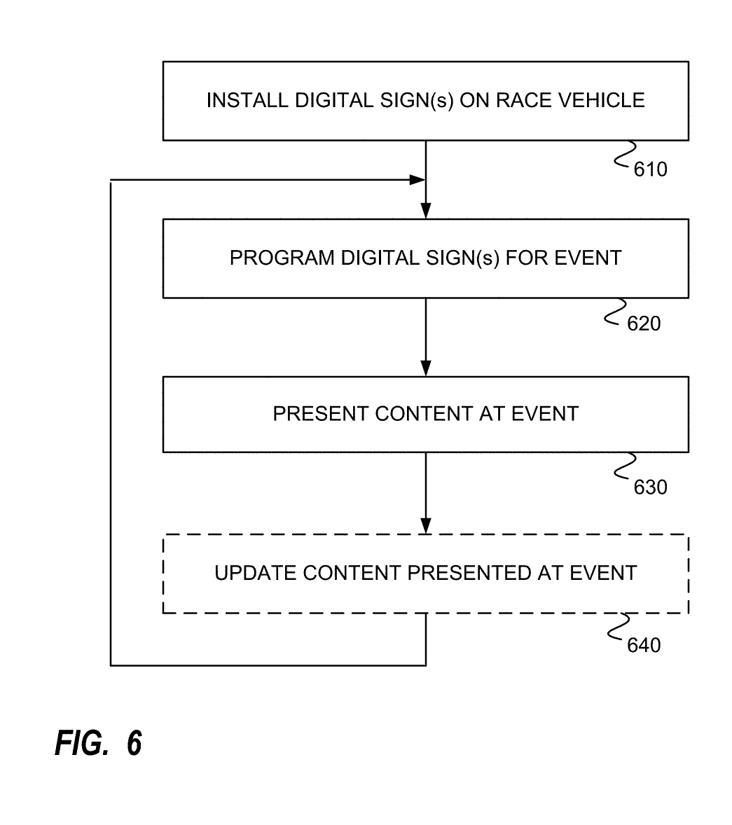

FIG. 6 illustrates an example high level flow diagram for using digital sign(s) (e.g., standard, pre-formed, flexible) on a racing vehicle. Initially, the digital sign(s) are installed on the race vehicle 610. When the race vehicle is scheduled to participate in an event the digital sign(s) are programmed for the event 620. The event may be, for example, a single race on a specific day or one or more races during an event that includes a plurality of races. The digital sign(s) may be programmed with specific content (e.g., words, images, videos) and instructions for presenting the content (e.g., static, scrolling, flashing). The content is then displayed at the event 630. The content may be displayed on the vehicle before, during and after the event (e.g., race). The content displayed may vary during the course of the event (e.g., different content or different manner of presenting the content before, during and after event). According to one embodiment, the digital sign(s) may be programmed to update the content presented during the first event if a specific event occurs (e.g., the vehicle wins the race) 640. For example, a banner may be added to the content that congratulates the driver on his victory or that offers discounts on products sold by the sponsor based on the victory. The steps 620-640 of the process may be continued over and over for multiple events.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A digital sign mounted to a racing vehicle, the digital sign including:
a display panel for presenting content;
an interface for receiving the content to be displayed;
a video processor for preparing the content for presentation on the display panel;
memory for storing the content;
a mobile power source; and
a mounting means for securing the digital sign to the racing vehicle.

2. The digital sign of claim 1, wherein the interface is a user interface.

3. The digital sign of claim 1, wherein the interface is a communication interface to communicate with an external device, wherein the external device provides the content.

4. The digital sign of claim 3, wherein the communications interface is a wireless interface.

5. The digital sign of claim 1, wherein the mobile power source is selected from a battery, a fuel cell, and a solar cell.

6. The digital sign of claim 1, wherein the digital sign is preformed to fit on a specific portion of the racing vehicle.

7. A racing vehicle for providing dynamic advertisement opportunities, the vehicle including
a body;
a digital sign formed to contour of the body and mounted thereto, wherein the sign is capable of presenting different content in different manners based on content and instructions received.

8. The vehicle of claim 7, wherein the racing vehicle is any type of competitive vehicle, including single wheel vehicles such as unicycles; two-wheel vehicles such as motorcycles, hoverboards, skateboards, and Segways; four-wheel vehicles such as go-karts, cars, trucks, tractors, skateboards, and lawn mowers; tracked vehicles such as snowmobiles; and other vehicles such as drones, hovercrafts, sailboats and motorboats.

9. The vehicle of claim 7, wherein the digital sign receives the content via a user interface.

10. The vehicle of claim 7, wherein the digital sign receives the content from an external device via a communication interface.

11. The vehicle of claim 7, wherein the communications interface is a wireless interface.

12. The vehicle of claim 7, wherein the digital sign includes a mobile power source.

13. The vehicle of claim 12, wherein the mobile power source is selected from a battery, a fuel cell, and a solar cell.

14. The vehicle of claim 7, wherein the digital sign receives power from the racing vehicle.

15. The vehicle of claim 7, wherein the content presented on the digital sign may be changed per event or within an event.

16. A method for providing dynamic advertisement opportunities on a racing vehicle, the method comprising
securing a digital sign to the racing vehicle;
programming the digital sign to identify content to be displayed on the digital design for an event;
displaying the content for the event;
re-programming the digital sign to identify different content to be displayed on the digital design for a subsequent event; and
displaying the different content for the subsequent event.

17. The method of claim 16, wherein
the content is displayed for at least some subset of before the event, during the event and after the event; and
the different content is displayed for at least some subset of before the subsequent event, during the subsequent event and after the subsequent event.

18. The method of claim 16, wherein the event is a race and the subsequent event is a subsequent race.

19. The method of claim 16, wherein the content may be modified during the event based on determination of a specific activity occurring.

20. The method of claim 16, wherein the racing vehicle is any type of competitive vehicle, including single wheel vehicles such as unicycles; two-wheel vehicles such as motorcycles, hoverboards, skateboards, and Segways; four-wheel vehicles such as go-karts, cars, trucks, tractors, skateboards, and lawn mowers; tracked vehicles such as snowmobiles; and other vehicles such as drones, hovercrafts, sailboats and motorboats.
